(19) United States
(12) Patent Application Publication
(10) Pub. No.: US 2022/0327001 A1
(43) Pub. Date: Oct. 13, 2022

(54) MULTI-CLOUD SPOT INSTANCE MARKET

(71) Applicant: Core Scientific Operating Company, Bellevue, WA (US)

(72) Inventors: Ian Ferreira, Issaquah, WA (US); Fernando Sierra, Villanueva de la Serena (ES); Maxim Alt, San Francisco, CA (US)

(21) Appl. No.: 17/715,567

(22) Filed: Apr. 7, 2022

Related U.S. Application Data
(60) Provisional application No. 63/172,298, filed on Apr. 8, 2021.

(51) Int. Cl. G06F 9/50; G06F 9/48

(52) U.S. Cl. CPC G06F 9/5072; G06F 9/5077; G06F 9/5055; G06F 9/505; G06F 9/4881

(57) ABSTRACT

An improved method for managing multi-cloud spot markets for executing a computing job is disclosed. Multiple clouds may be searched automatically for available spot instances by stepping through different available instance types based on job requirements. The results may be sorted and filtered, and one or more preferred instance types may be selected from the sorted and filtered results. The computing job may be automatically deployed to the selected instance types. If the selected spot instance is no longer available, an alternate instance may be suggested. Redundant deployment to different instance types on the same or different clouds may be enabled, and machine learning may be used to predict future availability of instance types.

### CROSS-REFERENCE TO RELATED APPLICATION

This application claims the benefit of and priority to U.S. Provisional Patent Application Ser. No. 63/172,298, filed on Apr. 8, 2021, the disclosure of which is hereby incorporated by reference in its entirety as though fully set forth herein.

### TECHNICAL FIELD

The disclosure relates generally to managing cloud computing instances, and more specifically to multi-cloud spot instance market management.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Data intensive computing applications such as machine learning (ML), artificial intelligence (AI), data mining, and scientific simulation (often called workloads) frequently require large amounts of computing resources, including storage, memory, and computing power. As the time required for a single system or processor to complete many of these tasks would be too great, they are typically divided into many smaller tasks that are distributed to large numbers of computing devices or processors such as central processing units (CPUs) or specialized processors such as graphics processing units (GPUs), Tensor Processing Unit (TPUs) or field programmable gate arrays (FPGAs) within one or more computing devices (called nodes) that work in parallel to complete them more quickly. Specialized computing systems (often called clusters) have been built that offer large numbers of nodes that work in parallel. These systems have been designed to complete these tasks more quickly and efficiently. Clusters can have different topologies (i.e., how compute resources are interconnected within a node or over multiple nodes). Groups of these specialized computing systems are provided for access to users by many different cloud service providers.

Each cloud service provider has many different configurations (called instance types) that they offer at different prices. For example, a user may select between configurations having different numbers of CPUs, different generations or types of CPUs (e.g., x64, ARM, RISC-V) different amounts of memory, different amounts of storage, different types of storage (e.g., flash or disk), and different numbers and types of accelerators (e.g., GPUs, TPUs, FPGAs). While not every possible combination is typically available, there may be large numbers of different configurations available at each cloud provider. The price and availability of these instances change over time. For example, the most cost-effective way to secure use of these instances is to use “spot instances”, meaning they are not reserved and are available on a first come first served basis. Their availability and pricing may change over time (e.g., based on supply and demand) as different users access them. This is in contrast to a “reserved instance”, which is effectively a leased instance reserved exclusively for a user for a predetermined amount of time (e.g., one month).

As the number of cloud providers and instance types increases, it can be difficult for a user to select the best instance for their application without spending large amounts of time searching each individual cloud provider and comparing instance types. For at least these reasons, there is a desire for an improved method for managing multi-cloud spot instance markets.

The foregoing discussion is intended only to illustrate examples of the present field and is not a disavowal of scope.

### SUMMARY

Improved systems and methods for managing multi-cloud spot instance markets are contemplated. By searching multiple clouds automatically, stepping through different instance types based on job requirements, and filtering the results for the user to surface recommended cloud and instance types, the previously time consuming and tedious process can be improved. This may enable the user to more quickly select the most cost-effective instance types available at the time.

In one embodiment, the improved method comprises (a) identifying a set of job requirements for a computing job, (b) picking a selected cloud from a plurality of clouds, (c) creating a list of available cloud instance types by querying the selected cloud for availability information for a set of instance types that match the set of j ob requirements, (d) repeating (b) and (c) for one or more additional clouds, (e) selecting a first preferred instance type from the list of available instance types, and (f) deploying the computing job to the first preferred instance type.

In some embodiments, the method may further comprise stepping through each instance type in the set of instance types based on a selected range, wherein the selected range is based on the set of job requirements, and sorting and filtering the list of available instance types.

In some embodiments, the method may also comprise detecting that the first preferred instance type is no longer available and in response thereto deploying to an alternate instance type from the list of available instance types, wherein the alternate instance type is a next closest available instance type to the first preferred instance type, which may be selected based on a user input. Pricing information for the list of available instance types may be collected by querying the selected cloud for a set of instance types that match the set of job requirements.

In some embodiments, the method may further comprise selecting a second preferred instance type from the list of available instance types, and deploying the computing job to the second preferred instance type for redundancy, wherein the computing job executes in parallel on the first preferred instance type and second preferred instance type.

In another embodiment, the method may comprise (a) prompting a user for a computing job, (b) determining a set of job requirements for the computing job, (c) picking a selected cloud from a plurality of clouds, (d) creating a list of available instance types by querying the selected cloud for availability information for a set of instance types that match the set of job requirements, (e) repeating (b) and (c) for one or more additional clouds, (f) prompting the user to select a first preferred instance type from the list of available instance types, and (g) deploying the computing job to the first preferred instance type.

In some embodiments, the method may further comprise checking a database of previous query results corresponding to any of the set of instance types, and in response to finding previous availability data not older than a threshold, using that previous availability data in lieu of querying.

In some embodiments, the method may further comprise stepping through each instance type in the set of instance types based on a selected range, wherein the selected range is based on the set of job requirements, collecting pricing information for the list of available instance types by querying the selected cloud for pricing information for the set of instance types that match the set of job requirements, selecting a second preferred instance type from the list of available instance types, and deploying the computing job to the second preferred instance type, wherein the computing job executes in parallel on the first selected instance type and second preferred instance type.

In some embodiments, the method may further comprise detecting that the first preferred instance type is no longer available and in response thereto prompting the user to select an alternate instance type from the list of available instance types, or automatically selecting the next closest available instance type for deployment.

The method may be implemented in software (e.g., on a non-transitory, computer-readable storage medium storing instructions executable by a processor of a computational device that when executed cause the computational device to perform the method). The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a schematic view generally illustrating an example of a system for managing multi-cloud spot instance markets according to teachings of the present disclosure.

FIG. 2 is a flow diagram generally illustrating an example of an improved method for managing a multi-cloud spot instance market according to teachings of the present disclosure.

FIG. 3 is a flow diagram generally illustrating another example of an improved method for managing a multi-cloud spot instance market with support for redundancy according to teachings of the present disclosure.

FIG. 4 is a flow diagram generally illustrating an example of an improved method for managing a multi-cloud spot instance market using machine learning according to teachings of the present disclosure.

FIG. 5 is a flow diagram generally illustrating an example of an improved method for managing a multi-cloud spot instance market using machine learning according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

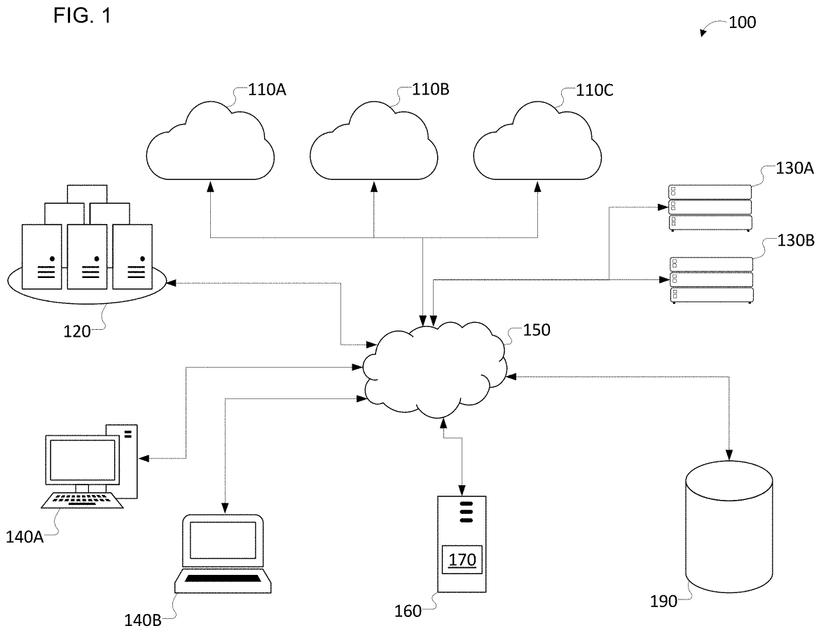

Turning now to FIG. 1, an example embodiment of a system 100 for managing multi-cloud spot instance markets according to teachings of the present disclosure is shown. In this example, the system 100 is managed by a management server 160, which may for example provide users access to a spot instance market via a platform as a service (PAAS) or software as a service (SAAS). Users may for example access the PAAS/SAAS service from their on-premises network-connected PCs, servers, or workstations (140A) and laptop or mobile devices (140B) via a web interface.

Management server 160 is connected to a number of different computing devices and services via local or wide area network connections 150 such as the Internet. The computing services may include, for example, cloud computing providers 110A, 110B, and 110C. These cloud computing providers may provide access to large numbers of computing devices (often virtualized) with different configurations called instance types. For example, instance types with one or more virtual CPUs may be offered in different configurations with different amounts of accompanying memory, storage, accelerators, etc. In addition to cloud computing providers 110A, 110B, and 110C, in some embodiments, management server 160 may also be configured to communicate with bare metal computing devices 130A and 130B (e.g., non-virtualized servers), as well as a datacenter 120 including for example one or more supercomputers or high-performance computing (HPC) systems (e.g., each having multiple nodes organized into clusters, with each node having multiple processors and memory), and storage system 190. Bare metal computing devices 130A and 130B may for example include workstations or servers optimized for machine learning computations and may be configured with multiple CPUs and GPUs and large amounts of memory. Storage system 190 may include storage that is local to management server 160 and or remotely located storage accessible through network 150 and may include non-volatile memory (e.g., flash storage), hard disks, and even tape storage.

Management server 160 may be a traditional PC or server, a specialized appliance, one or more nodes within a cluster (e.g., running within a virtual machine or container). Management server 160 may be configured with one or more processors (physical or virtual), volatile memory, and non-volatile memory such as flash storage or internal or external hard disk (e.g., network attached storage accessible to management server 160).

Management server 160 may be configured to run a multi-cloud spot instance market management application 170 that receives jobs and manages the allocation of resources from distributed computing system 100 to run them. In one embodiment, the jobs may be configured to run within containers (e.g., Kubernetes with Docker containers, or Singularity) or virtualized machines. Kubernetes is an open-source system for automating deployment, scaling, and management of containerized applications. Singularity is a container platform popular for high performance workloads such as artificial intelligence and machine learning. Management application 170 is preferably implemented in software (e.g., instructions stored on a non-volatile storage medium such as a hard disk, flash drive, or DVD-ROM and executable by a processor of a computational device such as management server 160), but hardware implementations are possible. Software implementations of management application 170 may be written in one or more programming languages or combinations thereof, including low-level or high-level languages (e.g., Python, Rust, C++, C#, Java, JavaScript, or combinations thereof). The program code may execute entirely on the management server 160, partly on management server 160 and partly on other computing devices such as a user's network-connected PCs, servers, or workstations (140A) and laptop or mobile devices (140B).

The management application 170 may be configured to provide an interface to users (e.g., via a web application, portal, API server or command line interface) that permits users and administrators to submit applications (also called jobs) via their network-connected PCs, servers, or workstations (140A), or laptop or mobile devices (140B). The management application 170 may present the user with controls to specify the application, the type of application (e.g., TensorFlow, scikit-learn, Caffe, etc.), the data sources to be used by the application, designate a destination for the results of the application, and selected application requirements (e.g., parameters such as a minimum number of processors to use, a minimum amount of memory to use, a minimum number of accelerators such as GPUs or TPUs or FPGAs, a minimum interconnection type or speed, cost limits, time limit for job completion, etc.). The management application may then select and search multiple clouds (e.g., clouds 110A-B) that offer spot instance types meeting the requirements. The management application may access the selected cloud systems, determine spot instance availability and pricing, and assemble a list of available instance types by stepping through different instance types (e.g., 2 CPUs, 4CPUs, 6 CPUs, etc.) for each selected cloud service. The resulting list may for example be filtered to offer the best matches to the user from the available instance types. The management application 170 may present this to the user and permit them to select one to be used to run the application. The management application 170 may then deploy the application to the selected cloud instance type, provide progress monitoring for the application, and once the job has completed provide the results to the user, and decommission/destroy the instance.

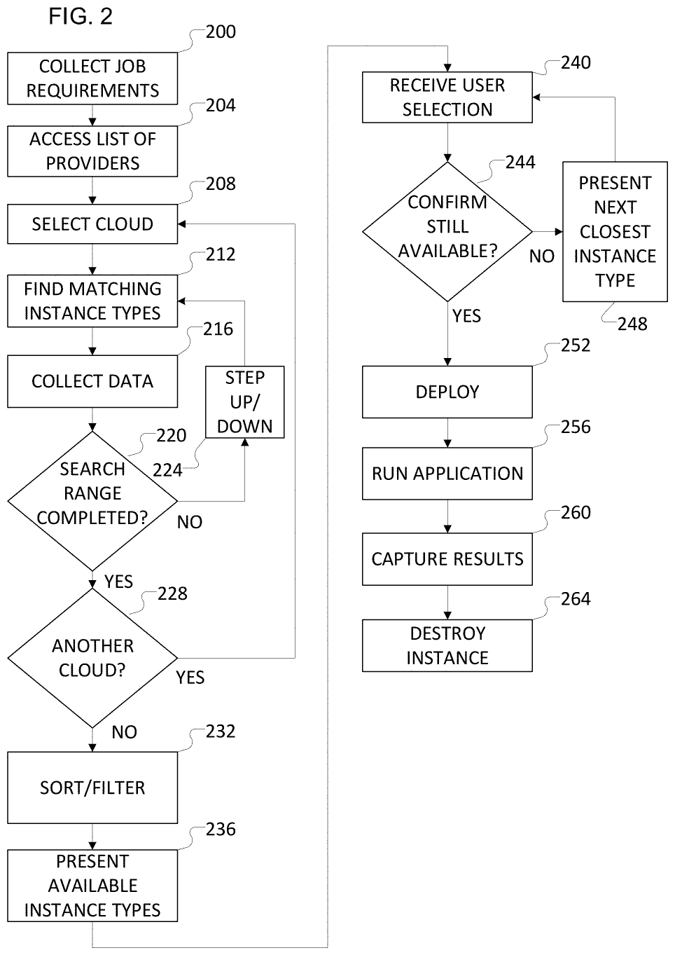

Turning now to FIG. 2, a flow diagram generally illustrating an example embodiment of an improved method for managing a multi-cloud spot instance market according to teachings of the present disclosure is shown. In this embodiment, job requirements are collected (step 200). For example, a minimum number of CPUs, a minimum number of GPUs, maximum execution time, minimum storage, data file size, geographic restrictions, and or minimum interconnection type/speed may be collected. These may for example be collected from a job metadata file, from previously stored job history (in the event the job is a repeat job or similar to a previous job), or interactively by prompting the user (e.g., via a web interface).

A list of registered cloud providers may be accessed (step 204), and a cloud provider may be selected (step 208). For example, system administrators may configure the system with a list of available cloud providers and associated metadata, such as which countries/regions they operate in, which types of instance types they offer, etc. In some embodiments, the list may not be limited to public cloud providers. In addition to public cloud providers, supercomputer centers or other non-traditional providers of computing resources may also be included as a cloud provider (e.g., if the owner of the supercomputer has registered their system to participate in the spot market). While they may not have the plethora of different instance types available that traditional large public cloud providers offer, they may nevertheless be able to participate with as few as a single available instance type.

The selected cloud provider may be queried for the availability of one or more instance types that meet the current job's requirements (step 212) and associated data may be collected (step 216). For example, the configuration, price and number of instances available of a particular instance type may be collected. Based on the job requirements and or instance types offered by the selected cloud provider, a range may be used for each cloud provider. For example, if a job requirement is at least 2 CPUs and at least 2 GPUs, and a particular cloud provider offers various combinations of CPUs and GPUs from 1:1 up to 8:16, then the search range may be from 2:2 to 8:16. If collecting data for the search range has not been completed, the query may be stepped up or down (step 224) for additional matching instance types, and the cloud may again be queried for the availability of one or more instance types that meet the current job's requirements (step 212), associated data may be collected (216), and the process may be repeated until the search range has been completed (step 220). Another cloud provider may be selected (step 228), and the process may be repeated. While the flowchart in the figure may be interpreted to depict a serial process, queries to multiple cloud provides may be submitted in parallel to speed up the process.

The list of available instance types may be filtered and or sorted (step 232) and presented to the user (step 236). For example, in one embodiment if a large number of instance types are available, they may be sorted and presented to the user from lowest cost to highest cost. In another example embodiment, they may be filtered to provide a lowest cost option, a highest performance option, and a best bargain option (e.g., largest price discount relative to a reserved instance). Different instance types may be sorted for example based on relative performance (e.g., based on historical benchmark data collected by the system, wherein the benchmark is selected to from a set of benchmarks to approximate the user's application). The user may be presented with controls to select what type of filtering or sorting they prefer.

The user's selection from the available options maybe received (step 240), and the availability of that option may be confirmed (step 244). For example, an available instance may become unavailable during the delay between the system initially receiving the availability information and the user making their selection. In some embodiments this confirmation may only be performed if longer that a predetermined delay has occurred. If the selected instance type is no longer available, the next closest instance type may be presented to the user for confirmation (step 248). In other embodiments, the next closest instance type may be automatically selected and used without addition user intervention (e.g., if there is no difference in price or performance).

The job may then be deployed to the selected instance type (step 252). This may entail creating an instance on the selected cloud provider's system of the selected instance type and loading the application onto the instance once it has been created. For example, Docker or Singularity container(s) with the application may be automatically loaded onto the instance once it is created. Network ports/connections (e.g., SSH, VPN) may be configured, node interconnections may be configured, data sources may be transferred (or connected to), performance monitoring tools (e.g., perf) may be loaded and configured, and a destination for results may be configured.

The application may be run (step 256), and the results may be captured (step 260). This may for example include collecting performance data (e.g., from the perf tool) as well as the results from the application's run. Once the job is completed and the results have been captures, the instance(s) may be deleted/destroyed (step 264). As many cloud providers charge based on time (e.g., per minute), it may be advantageous to destroy the instance as soon as possible.

In some embodiments, the availability information may be stored with a timestamp, and if the user submits (or resubmits) an application within a predetermined time period (e.g., 10 minutes), the stored historical availability data may be used in lieu of performing the search.

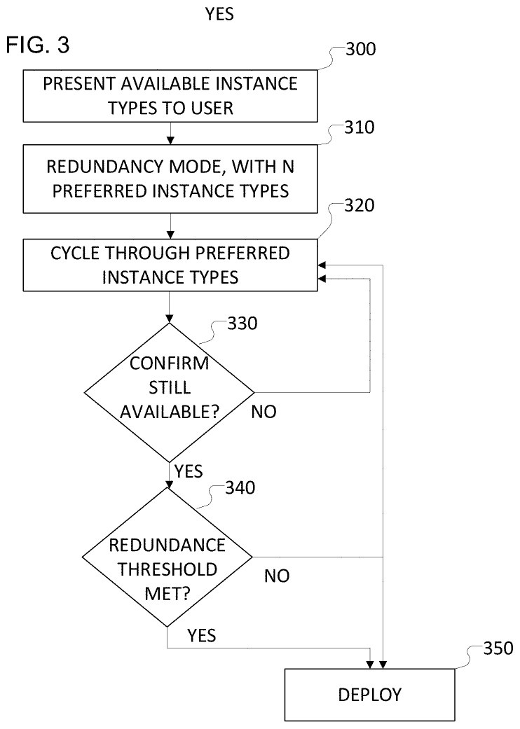

Turning now to FIG. 3, a flow diagram generally illustrating another example of an improved method for managing a multi-cloud spot instance market according to teachings of the present disclosure is shown. In this embodiment, redundant instance type selections are enabled. Redundancy might be desirable for a user that wants to compare the performance of a job in parallel on two different instance types. For example, the administrator of the system for managing the spot market may periodically use this function to run many redundant instances of a benchmark across different instance types to populate a database of relative performance rankings that can be used in filtering/sorting different available instance types when presented to the user. Redundancy might also be desirable for a user that has a job that has a higher likelihood of crashing, or that is selecting preemptable instance types. A cloud provider might provide steep discounts for using currently available computing resources but are willing to be kicked off the system without notice. This may allow them to sell computing resources that have been reserved for another customers. If that customer happens to access the resources, the cloud provider may terminate the user's application in the middle of execution. While the user may prefer the cost savings, the user may also want to hedge their bets by running on two such preemptable instances, or one high performance but preemptable instance and one low performance but non-preemptable instance (to guarantee completion). Users having a job that is subject to randomly crashing may also occasionally desire to run in redundant mode as a hedge against their application crashing if the results are required within a tight time window.

In one embodiment, once the list of available instance types has been presented to the user (step 300), the user may be presented with a control to select redundancy mode. In redundancy mode, like a RAID mode for storage, the user selects N (multiple) preferred instance types (step 310). The system may then cycle through each of the N preferred instance types (step 320), confirming its availability (step 330) until the desired number of available instance types (i.e., the redundancy threshold) is met (step 340), and the application is deployed to each available instance type (step 350) up to the redundancy threshold. For example, with a redundancy threshold of two, if the list of the user's preferred instance types are:
Cloud A type 3 (4 CPUs/8 GPUs)
Cloud B type 4 (6 CPUs/12 GPUs)
Cloud C type B (4 CPUs/4 GPUs),
Cloud A type 2 (2 CPUs/1 GPU),
   and Cloud A type 3 is available, Cloud B type 4 is unavailable, and Cloud C type B is available, the application is deployed to Cloud A type 3 and Cloud C type B. This may be done in parallel. In some embodiments, the system may destroy all the instances once the first one completes (e.g., to save the user money). In other embodiments, the user might be given the option to allow all redundant instances to complete, and if results are successfully obtained from multiple instance executions, the results may be compared to confirm that they are the same. While applications that incorporate random data perturbations might not generate the same results across multiple executions, other applications may be expected to generate the same results. In some embodiments, the user may be presented with a control to specify a budget limit or threshold (e.g., do not exceed a certain total spend across all the redundant instances).

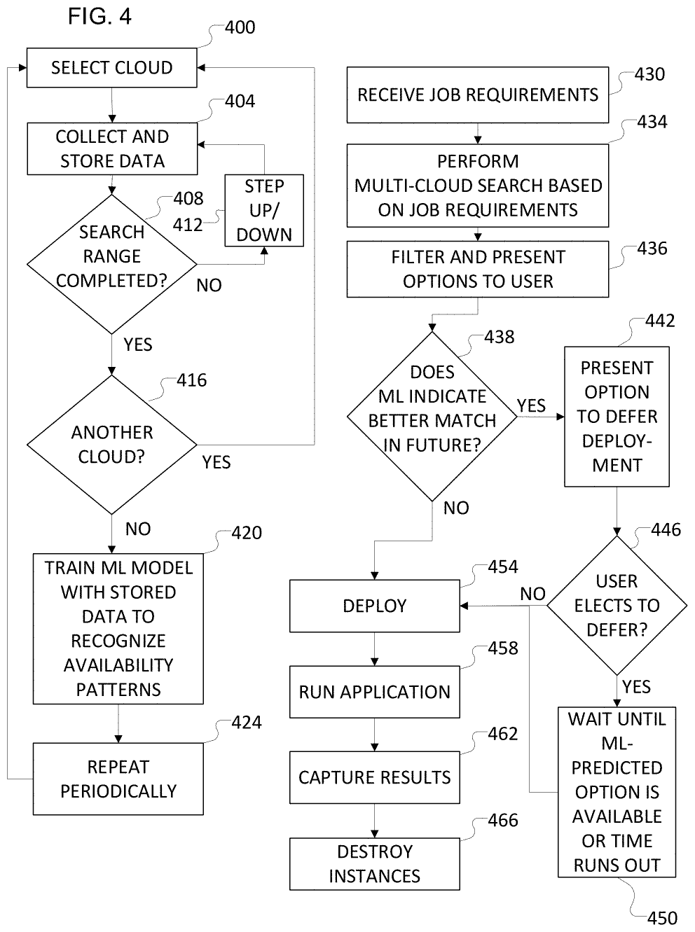

Turning now to FIG. 4, a flow diagram generally illustrating another example of an improved method for managing a multi-cloud spot instance market using machine learning according to teachings of the present disclosure is shown. In this embodiment, a training process (shown as steps 400 through 424 in the figure) is performed. The training process may comprise selecting a cloud provider (step 400), collecting and storing data for instance types from the cloud provider (step 404) and stepping up/down through different instance types (step 412) until a search range has been completed (step 408). This process may be repeated for multiple cloud providers (step 416), and the data collected may be stored and used to train a machine learning model to recognize availability patterns (step 420). For example, a machine learning model may be created (e.g., using the scikit-learn package in Python) to recognize if there are certain times (e.g., times of day or days of week) where availability for certain instance types is predicted to be higher. This training process may be repeated (step 424) with additional data being collected over time.

The model from the training process may then be applied to improve the spot instance market management system. The user's job requirements may be received (step 430), and a multi-cloud provider search may be performed based on those requirements to identify available instance types (step 434). The list of available instance types may be filtered and or sorted and presented to the user (step 436) as described above. The results may be fed into the machine learning (ML) model, and if the ML model indicates that a better match is likely at some future time (step 438), the user may be presented with an option to defer deployment (step 442) for a selectable amount of time. For example, if the user is requesting an instance at noon local time Friday, the ML model may indicate that a better deal (e.g., a twice as powerful system at half the cost) is likely to be available in the next 8 hours. The user may be presented with an option to defer the deployment up to a selected time delay (e.g., 12 hours) in hopes of securing a reduced cost (step 446). The user may elect to deploy immediately (step 454) or wait, in which case the system may want until the predicted better deal becomes available (e.g., periodically checking the clouds for availability) or the maximum wait time is reached (step 450), at which time the application is deployed (step 454), the application is run (step 458), results are captured (step 462), and the instances are destroyed (step 466) as described above.

In some embodiments, the user may also be offered redundancy options (as described above), e.g., with the ML model predicting whether a better time or deal for running redundant instances is likely in the near future. The ML model may take into account the job requirements (e.g., the instance type must be within a certain geographic region) when making its predictions, and the confidence level of the ML model may be presented to the user along with the option to defer. For example, the user may be informed that there is a predicted 80% chance of a lower cost option with the same or better performance being available within the next 12 hours.

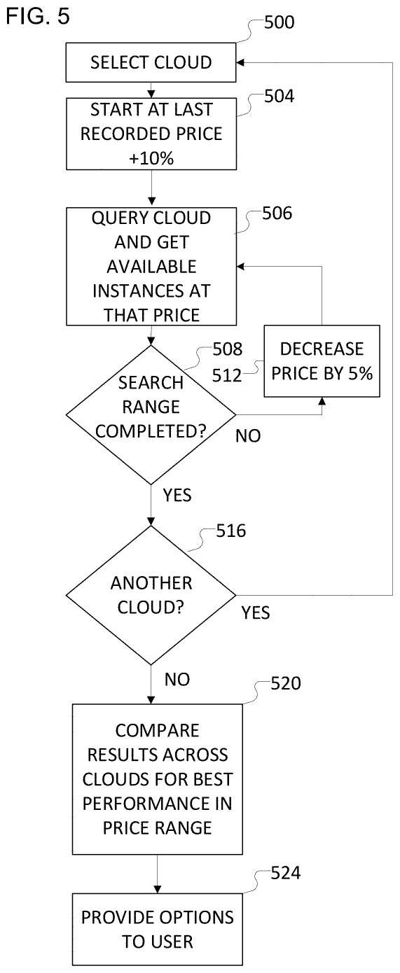

Turning now to FIG. 5, a flow diagram generally illustrating another example of an improved method for managing a multi-cloud spot instance market using machine learning according to teachings of the present disclosure is shown. In this embodiment, the method steps through different prices (e.g., name your price) in order to find matching available instance types. A cloud is selected (step 500), and an initial price is selected based on a last recorded price (e.g., a last recorded price for the same or similar instance type), plus some adjustment factor, e.g., a fixed increase of 10% (step 504). The selected cloud is queried for instances available at that price (step 506). If the search range (e.g., +10% of last price to −10% of last price) has not been completed (step 508), the price is adjusted (step 512) by increasing or decreasing a fixed amount, and the process is repeated until the search range has been completed. The search process may be repeated for other clouds (step 516) until data for all clouds of interest has been collected. The available instance types and associated pricing are compared, e.g., within clouds, across different clouds, (step 520), and selected options are provided to the user (step 524) and may be filtered and or sorted as described above. This is but one possible method for price discovery, and other methods are possible and contemplated. For example, heuristics and price prediction algorithms may be applied based on historical collected pricing information collected over time to improve efficiency and or effectiveness. While steps are shown in the figure in series, in some embodiments multiple clouds may be searched at the same time (e.g., in parallel).

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method for managing multi-cloud spot markets, the method comprising:
(a) identifying a set of job requirements for a computing job;
(b) picking a selected cloud from a plurality of clouds;
(c) creating a list of available instance types by querying the selected cloud for availability information for a set of instance types that match the set of job requirements;
(d) repeating (b) and (c) for one or more additional clouds;
(e) selecting a first preferred instance type from the list of available instance types; and
(f) deploying the computing job to the first preferred instance type.

2. The method of claim 1, wherein (c) further comprises stepping through each instance type in the set of instance types based on a selected range, wherein the selected range is based on the set of job requirements.

3. The method of claim 1, further comprising sorting and filtering the list of available instance types.

4. The method of claim 1, further comprising detecting that the first preferred instance type is no longer available and in response thereto deploying to an alternate instance type from the list of available instance types, wherein the alternate instance type is a next closest available instance type to the first preferred instance type.

5. The method of claim 1, wherein the first preferred instance type is selected based on a user input.

6. The method of claim 1, further comprising collecting pricing information for the list of available instance types by querying the selected cloud for pricing information for the set of instance types that match the set of job requirements.

7. The method of claim 1, further comprising:
(g) selecting a second preferred instance type from the list of available instance types; and
(h) deploying the computing job to the second preferred instance type, wherein the computing job executes in parallel on the first preferred instance type and second preferred instance type.

8. A non-transitory, computer-readable storage medium storing instructions executable by a processor of a computational device, which when executed cause the computational device to:
(a) identify a set of requirements for a computing job;
(b) select a cloud from a plurality of clouds;
(c) query the selected cloud for availability information for a set of instance types that match the set of requirements;
(d) create a list of available cloud instance types;
(e) repeating (b), (c), and (d) for one or more additional clouds;
(f) select a first preferred instance type from the list of available cloud instance types; and
(g) deploy the computing job to the first preferred instance type.

9. The non-transitory, computer-readable storage medium of claim 8, wherein the instructions when executed cause the computational device to step through each instance type in the set of instance types based on a selected range, wherein the selected range is based on the set of requirements for the computing job.

10. The non-transitory, computer-readable storage medium of claim 8, wherein the instructions when executed cause the computational device to sort and filter the list of available cloud instance types.

11. The non-transitory, computer-readable storage medium of claim 8, wherein the first preferred instance type is selected based on a user input.

12. The non-transitory, computer-readable storage medium of claim 8, wherein the instructions when executed cause the computational device to collect pricing information for the list of available cloud instance types by querying the selected cloud for pricing information for the set of instance types that match the set of requirements.

13. The non-transitory, computer-readable storage medium of claim 8, wherein the instructions when executed cause the computational device to:
(h) select a second preferred instance type from the list of available cloud instance types; and
(i) deploy the computing job to the second preferred instance type, wherein the computing job executes in parallel on the first preferred instance type and second preferred instance type.

14. A method for managing multi-cloud spot markets, the method comprising:
(a) prompting a user for a computing job;
(b) determining a set of job requirements for the computing job;
(c) picking a selected cloud from a plurality of clouds;
(d) creating a list of available instance types by querying the selected cloud for availability information for a set of instance types that match the set of job requirements;
(e) repeating (b) and (c) for one or more additional clouds;
(f) prompting the user to select a first preferred instance type from the list of available instance types; and
(g) deploying the computing job to the first preferred instance type.

15. The method of claim 14, wherein (d) further comprises checking a database of previous query results corresponding to any of the set of instance types, and in response to finding historical availability data not older than a threshold, using that historical availability data in lieu of querying.

16. The method of claim 14, wherein (c) further comprises stepping through each instance type in the set of instance types based on a selected range, wherein the selected range is based on the set of job requirements.

17. The method of claim 14, further comprising collecting pricing information for the list of available instance types by querying the selected cloud for pricing information for the set of instance types that match the set of job requirements.

18. The method of claim 14, further comprising:
(i) selecting a second preferred instance type from the list of available instance types; and
(j) deploying the computing job to the second preferred instance type, wherein the computing job executes in parallel on the first preferred instance type and second preferred instance type.

19. The method of claim 14, further comprising detecting that the first preferred instance type is no longer available and in response thereto prompting the user to select an alternate instance type from the list of available instance types.
